(19) United States
(12) Patent Application Publication
(10) Pub. No.: US 2007/0221309 A1
(43) Pub. Date: Sep. 27, 2007

(54) Tire having belt ply edge protector

(76) Inventors: Martin Paul Cohen, Fairlawn, OH (US); Marcie Jan Simpson Harvey, Hudson, OH (US); Joseph Alan Incavo, Hudson, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/389,913

(22) Filed: Mar. 27, 2006

(51) Int. Cl. B60C 9/00

(52) U.S. Cl. 152/532; 152/537

(57) ABSTRACT

This invention relates to a pneumatic rubber tire having a circumferential rubber tread and an underlying (underlying said tread) circumferential belt ply layer comprised of a cord reinforced rubber composition, wherein the axial edges of said circumferential belt ply layer have a protective edge protector in a form of a rubber cap, or boot, of a rubber composition which contains a migration resistant antidegradant.

### FIELD OF THE INVENTION

This invention relates to a pneumatic rubber tire having a circumferential rubber tread and an underlying (underlying said tread) circumferential belt ply layer comprised of a cord reinforced rubber composition, wherein the axial edges of said circumferential belt ply layer have a protective edge protector in a form of a rubber cap, or boot, of a rubber composition which contains a migration resistant antidegradant.

### BACKGROUND OF THE INVENTION

Rubber tires, particularly light and heavy truck tires, contain one or more components (e.g. circumferential belt plies) which contain wire reinforcement which is often encapsulated with natural rubber, namely natural cis 1,4-polyisoprene rubber.

The use of natural rubber (cis-1,4-polyisoprene rubber) for encapsulating the wire reinforcement, particularly for larger tires designed to carry heavy loads is usually preferred because of natural rubber's excellent tear strength and cut growth resistance which is important for the durability of the tire casing, or carcass; and building tack for holding green, uncured, rubber components together which is important when building, or assembling, various tire components together.

It is often desirable to protect the axial edges of the belt plies by encapsulating the axial belt edges with rubber gum strips (gum strips in a sense that they are exclusive of and do not contain a woven cord reinforcement) which extend around the (outer) axial edges of the belt in a form of what might be referred to, for example, a cap or a boot and/or rubber gum based wedges positioned between the (outer) axial edges of two belt plies.

In practice, it is desired to enhance the protective aspect of such belt edge gum rubber protectors. For this invention, such enhancement is created by an inclusion in the gum strip of at least one migration resistant antidegradant which are resistant to migration within the gum strip rubber composition in order to promote an extended period of the age protective aspect of the presence of the antidegradant within the rubber protector, namely the aforesaid protective cap, or boot, in contact with the axial edge of the belt ply.

In the description of this invention the term “phr” relates to parts by weight of an ingredient per 100 parts by weight of elastomer. The terms “elastomer” and “rubber” are used interchangeably unless otherwise indicated. The terms “cured” and “vulcanized”, as well as “uncured” and unvulcanized” where used, are used interchangeably, respectively, unless otherwise indicated. The terms rubber “compound” and rubber “composition” are used interchangeably unless otherwise indicated.

### SUMMARY AND PRACTICE OF THE INVENTION

In accordance with this invention, a tire is provided having a circumferential rubber tread and an underlying circumferential rubber belt ply layer of cord reinforced rubber composition, wherein the axial edges of said belt ply layer are individually covered (protected by encapsulation) by a rubber layer boot over of each of said axial edges of a non-cord containing rubber composition (a rubber composition which does not contain a woven cord reinforcement) comprised of, based upon parts by weight per 100 parts by weight rubber, (phr):

(A) at least one conjugated diene-based elastomer;

(B) about 40 to about 100 phr of particulate reinforcing filler comprised of
(1) rubber reinforcing carbon black, or
(2) about 3 to about 50 phr, alternately from about 3 to about 40, phr of precipitated silica, and up to about 70 phr of rubber reinforcing carbon black, and

(C) at least one migration resistant antidegradant comprised of at least one of 2,4,6-tris(N-1,4-dimethylpentyl-p-phenylenediamino)-1,3,5-triazine and benzeneamine, N-[4-(1,3-dimethyl(butyl)imino]-2,5-cyclohexadien-1-ylidene.

In further accordance with the invention, a tire is provided wherein said rubber layer boots individually extend over each of said axial edges of said circumferential belt layer and further extends to cover a portion of both of the adjacent outer surfaces of said circumferential belt ply layer.

In additional accordance with the invention, a tire is provided wherein said tire contains at least two of said circumferential belt ply layers;

wherein said circumferential belt ply layers are comprised of a first belt ply layer and a second belt ply layer;

wherein said second belt ply layer underlies said first belt ply layer and extends beyond the axial outer edges of said first belt ply layer, and

wherein each of said circumferential belt ply layers contains said rubber layer boot which extends over its axially outer edge and further extends over a portion of both of its adjacent outer surfaces; and

wherein a portion of said rubber layer boot on said outer surface of said second belt ply layer overlays a portion of the said rubber layer boot on said outer surface of said first belt ply layer, and optionally,

wherein a rubber wedge (non cord reinforced rubber composition) is positioned between said rubber layer boot on said outer surface of said first belt ply layer and said second belt ply layer and wherein said rubber wedge extends beyond the axially outer edge of at least one of said belt ply layers.

Optionally, said rubber composition, when said reinforcing filler includes precipitated silica, further may contain a silica coupling agent having a moiety reactive with hydroxyl groups (e.g. silanol groups) contained on the precipitated silica and another different moiety interactive with said conjugated diene-based elastomer.

Representative of such 2,4,6-tris(N-1,4-dimethylpentyl-p-phenylenediamino)-1,3,5-triazine is, for example, Durazone 37™ from the Chemtura Corporation which is understood to have a property of including a resistance to migration within the sulfur cured diene-based elastomer containing rubber composition from within the aforesaid protective boot to adjoining rubber components of the tire which would dilute the content of the said antidegradant in the rubber boot itself, based, at least in part, of its considerable bulk as compared to more conventional antidegradants which thus restricts its mobility within the sulfur cured rubber composition of the rubber boot.

Representative of such benzenamine, N-[4-(1,3-dimethyl(butyl)imino]-2,5-cyclohexadien-1-ylidene is, for example, 6-QDI™ from the Flexsys Company which is understood to have a property including a resistance to migration within the protective boot of sulfur cured diene-based elastomer containing rubber composition from within the aforesaid protective boot to adjoining rubber components of the tire which would dilute the content of the said antidegradant in the rubber boot itself, because, at least in part, of its reactivity with free radicals generated on the conjugated diene-based elastomer in the associated rubber composition during the mixing operation in which the rubber composition is prepared, which thereby restricts its mobility within the sulfur cured rubber composition of the rubber boot.

The rubber for said circumferential cord reinforced belt ply is comprised of a rubber composition, sometimes referred to as a wire coat compound where the cord reinforcement for the belt ply is a metal (e.g. steel) wire, is comprised of, for example, cis 1,4-polyisooprene rubber, (preferably natural cis 1,4-polyisoprene rubber), as a major portion (at least 50 phr) and which may optionally contain a minor portion (up to 50 phr such as for example from about 10 to 50 phr) of at least one other conjugated diene based elastomer.

If desired, the rubber composition for the cord reinforced belt ply itself may also contain at least one migration resistant antidegradant such as, for example at least one of the said such 2,4,6-tris(N-1,4-dimethylpentyl-p-phenylenediamino)-1,3,5-triazine and benzenamine, N-[4-(1,3-dimethyl(butyl)imino]-2,5-cyclohexadien-1-ylidene.

In practice, various wires, or cords, may be used for the rubber encapsulated wire reinforcement for the belt ply. Representative of various wires are, for example, brass coated steel wires which may sometimes more simply be referred to as steel wire reinforcement. Such wires are typically in a form of at least one wire filament (e.g. a monofilament) or a cord comprised of a plurality of twisted filaments, sometimes referred to as cabled filaments.

As known to one having skill in such the art, in order to sulfur cure the diene-based elastomer (e.g. cis 1,4-polyisoprene rubber) a sulfur vulcanizing agent is used. Examples of suitable sulfur vulcanizing agents include, for example, elemental sulfur (free sulfur) or a sulfur donating vulcanizing agent, for example, an amine disulfide, polymeric polysulfide or sulfur olefin adducts. Preferably, the sulfur vulcanizing agent is elemental sulfur in the insoluble form. The amount of sulfur vulcanizing agent will vary depending on the components of the rubber stock and the particular type of sulfur vulcanizing agent that is used. The sulfur vulcanizing agent is generally present in an amount ranging from about 0.5 to about 8 phr. Preferably, the sulfur vulcanizing agent is present in an amount ranging from about 0.75 phr to about 4 phr.

Conventional rubber additives may be incorporated in the rubber stock of the present invention. The additives commonly used in rubber stocks include fillers, plasticizers, waxes, processing oils, retarders, antiozonants, antioxidants and the like, where appropriate. The total amount of filler that may be used may range, for example, from about 30 to about 150 phr, depending somewhat upon the desired application. Various fillers such as for example, clays and carbon black might be used where appropriate. One or more plasticizers might be used where appropriate such as, for example, aromatic extract oils, petroleum softeners including asphaltenes, pentachlorophenol, saturated and unsaturated hydrocarbons and nitrogen bases, coal tar products, cumarone-indene resins and esters such as dibutylphthalate and tricresol phosphate. Common waxes which might be used, where appropriate, include, for example, paraffinic waxes and microcrystalline blends.

Sulfur vulcanization accelerators may be used to control the time and/or temperature required for vulcanization and to improve the properties of the vulcanizate. In one embodiment, a single accelerator system may be used; i.e., primary accelerator. The accelerator(s) may be used in amounts, such as for example, about 0.5 to about 4 phr, as may be appropriate. Suitable types of accelerators may be, for example, various amines, disulfides, guanidines, thioureas, thiazoles, thiurams, sulfenamides, dithiocarbamates and xanthates. The primary accelerator may preferably be a sulfenamide, a well known type of accelerator for sulfur vulcanization of diene-based elastomers. If a second accelerator is used, the secondary accelerator may preferably be a guanidine, dithiocarbamate or thiuram compound, also well known type of accelerator for sulfur vulcanization of diene-based elastomers.

The mixing of the rubber compound can be accomplished by methods known to those having skill in the rubber mixing art. For example, the ingredients are typically mixed in at least two stages, namely at least one non-productive stage followed by a productive mix stage. The final curatives are typically mixed in the final stage which is conventionally called the “productive” mix stage in which the mixing typically occurs at a temperature, or ultimate temperature, lower than the mix temperature(s) than the preceding non-productive mix stage(s). The sulfur and accelerator(s) are generally mixed in the productive mix stage. The terms “non-productive” and “productive” mix stages are well known to those having skill in the rubber mixing art.

### BRIEF DESCRIPTION OF THE DRAWINGS

Drawings are provided in order to better understand the invention, although it is not intended that the invention is limited to the presented drawings. In the drawings,

FIG. 1 (FIG. 1) is provided to illustrate a cross-section of a tread of a pneumatic tire.

FIG. 1A and FIG. 1B are provided to depict an indicated portion of FIG. 1.

### THE DRAWINGS

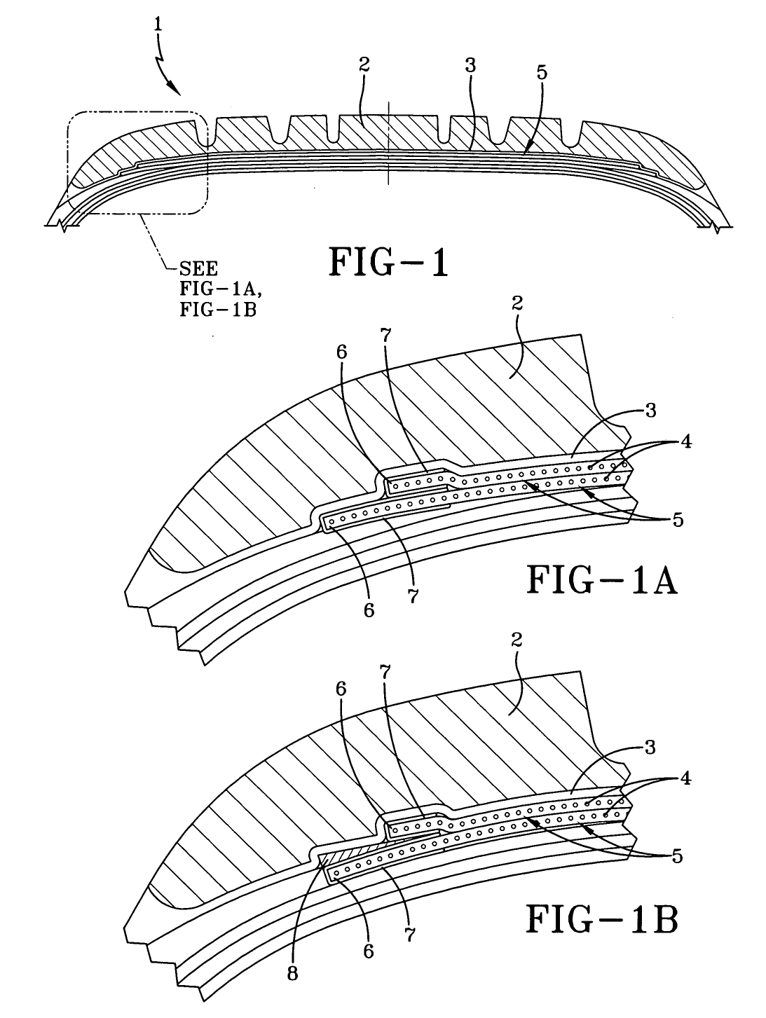

FIG. 1 is a cross-section of a circumferential tire tread (1) of a pneumatic tire of a cap/base construction composed of an outer cap layer (2), which contains the running surface of the tire, and underlying tread base layer (3). Two steel cord (4) reinforced circumferential belt plies (5), positioned one beneath the other, underlie said tread (1).

In FIG. 1A and FIG. 1B, the steel cords (4) of the belt plies, or belt ply layers, (5) run in a circumferential direction within the two belt plies (5) so that, therefore the ends of the steel cords (4) of the two belt plies (5) are shown in FIG. 1A and FIG. 1B.

It can be seen that the radially inner belt ply layer (5) underlies the radially outer belt ply layer (5) and extends beyond the axial outer edge of the radially outer belt ply layer (5).

In FIG. 1A, the outer edges (6) of the two belt plies, or belt ply layers, (5) are protected in a sense of having a protective, non-cord containing rubber layer, or boot, (7) positioned on and around and therefore encompassing the axially outer edges (6) of each of the two belt plies (5) which increases the gauge, or separation, between the axially outer ends of the two belt plies (5) as well as to insure that the axial edges of the belt plies (5) are covered by an appropriate rubber composition of the boot rubber layer (7).

In FIG. 1A it can be seen that the rubber layer boot rubber layer boots (7) individually extend over each of the said axial edges of said belt ply layers (5) and further extend to cover a portion of both of the adjacent outer surfaces of the said belt ply layers (5), wherein a portion of the rubber boot layer (5) on the outer surface of one belt ply layer overlays a portion of the rubber boot layer (5) on the outer surface of the other belt ply layer (5) in a manner to increase the gauge, or distance, between the two belt ply layers (5) near their axial outer edges.

FIG. 1B is similar to FIG. 1A except that an optional non-cord containing rubber wedge (8), which contains at least one of said migration resistant antidegradants, is positioned between the outer portions of the edges of the booted belt plies (5) which increases the gauge, or separation, between the axially outer ends of the two booted belt plies (5) even more than the booted belt plies of FIG. 1A.

The rubber compositions of the protective boots (7) and wedge (8) are comprised of a natural cis 1,4-polyisoprene based rubber composition which contain a migration resistant antidegradant in order to inhibit the migration of the antidegradant into the surrounding rubber components of the tire during both the cure and subsequent service of the tire, which would dilute the long term antidegradant effect for the protective boot (7) and wedge (8).

For FIG. 1A and FIG. 1B of the drawings, it is envisioned that either or both of the 2,4,6-tris(N-1,4-dimethylpentyl-p-phenylenediamino)-1,3,5-triazine and benzenamine, N-[4-(1,3-dimethyl(butyl)imino]-2,5-cyclohexadien-1-ylidene is exemplified as the migration resistant antidegradant being present in an amount of about 0.25 to about 5 parts by weight per hundred parts by weight (phr) of the natural rubber of the boot (7) and rubber wedge (8).

The present invention may be further understood by reference to the following exemplary example in which the parts or percentages are by weight unless otherwise indicated.

### EXAMPLE I

Rubber compositions are prepared comprised of natural cis 1,4-polyisoprene rubber for wherein rubber Sample A which contains a migration resistant antidegradant comprised of 2,4,6-tris(N-1,4-dimethylpentyl-p-phenylenediamino)-1,3,5-triazine as Durazone 37™ and rubber Sample B contained a migration resistant antidegradant comprised of benzenamine, N-[4-(1,3-dimethyl(butyl)imino]-2,5-cyclohexadien-1-ylidene as 6-QDI™ from the Flexsys Company.

Table 1 is a tire wire belt rubber compound formulation taken from The Vanderbilt Rubber Handbook, (1978), Page 653, which has been modified herein to include the 2,4,6-tris(N-1,4-dimethylpentyl-p-phenylenediamino)-1,3,5-triazine and benzenamine, N-[4-(1,3-dimethyl(butyl)imino]-2,5-cyclohexadien-1-ylidene migration resistant antidegradants.

The rubber compositions are prepared by blending the ingredients (including the rubber) in a non-productive mixing stage to a temperature within a range of from about 130° C. to about 180° C. in an internal rubber mixer followed by a productive mixing stage to a temperature within a range of from about 90° C. to about 120° C. in an internal rubber mixer, with the rubber mixture being removed from the rubber mixer and cooled to a temperature below 40° C. between mixing steps. Table 1 is representative of the ingredients for the rubber compositions.

TABLE 1

| | |
|---|---|
| Sample A | Sample B |

Non-Productive Mixing Step

| | | |
|---|---|---|
| Natural cis 1,4-polyisoprene rubber¹ | 100 | 100 |
| Carbon black (N330)² | 50 | 50 |
| “Agerite Resin D”³ | 0 or 1 | 0 or 1 |
| “Antozite 67”⁴ | 0 or 1 | 0 or 1 |
| Cobalt stearate | 2 | 2 |
| Zinc oxide | 8 | 8 |
| Antidegradant A⁵ | 3 | 0 |
| Antidegradant B⁶ | 0 | 3 |

Productive Mixing Step

| | | |
|---|---|---|
| Sulfur | 3.6 | 3.6 |
| Sulfur vulcanization accelerator⁷ | 0.65 | 0.65 |

¹Natural cis 1,4-polyisoprene rubber (SMR 5)
²Rubber reinforcing carbon black, (N330), an ASTM designation
³Polymerized 2,2,4-trimethyl-1,2-dihydroquinoline as Agerite Resin D ™ from RT
Vanderbilt
⁴N-(1,3-dimethylbutyl)-N′-phenyl-phenylenediamine as Antozite 67 ™ from RT
Vanderbilt
⁵Migration resistant antidegradant as 2,4,6-tris(N-1,4-dimethylpentyl-p-phenylenediamino)-1,3,5-triazine as Durazone 37 ™ from the Chemtura Corporation.
⁶Migration resistant antidegradant as benzamine, N-[4-(1,3-dimethyl(butyl)imino]-2,5-cyclohexadien-1-ylidene as 6-QDI ™ from the Flexsys Company
⁷Sulfur vulcanization accelerator of the sulfenamide type

### EXAMPLE II

A tire is prepared comprised of an outer circumferential tread of a cap/base construction, as herein described, which contains an underlying belt ply layer comprised of two superimposed belt ply layers as herein described and illustrated in the Drawings. The axial outer edges of the belt ply layers are protected by a rubber layer boot which covers each of said axial outer edges and extends over a portion of the surfaces of the belt ply layers in a manner illustrated in the Drawings. Optionally, a rubber wedge is provided and positioned between the axially outer portion of said boot encapsulated outer edged belt ply layers in a manner illustrated in the Drawings. The rubber composition of Sample A or Sample B of Example I is used for said rubber boot layers and said optional rubber wedge.

While certain representative embodiments and details have been shown for the purpose of illustrating the invention, it will be apparent to those skilled in this art that various changes and modifications may be made therein without departing from the spirit or scope of the invention.

What is claimed is:

1. A tire having a circumferential rubber tread and a circumferential rubber belt ply layer of cord reinforced rubber composition which underlies said rubber tread, wherein the axial edges of said belt ply layer are individually covered by a rubber layer boot over each of said axial edges of a non-cord containing rubber composition comprised of, based upon parts by weight per 100 parts by weight rubber, (phr):
(A) at least one conjugated diene-based elastomer;
(B) about 40 to about 100 phr of particulate reinforcing filler comprised of
(1) rubber reinforcing carbon black, or
(2) about 3 to about 50 phr of precipitated silica, and up to about 70 phr of rubber reinforcing carbon black, and
(C) at least one migration resistant antidegradant comprised of at least one of 2,4,6-tris(N-1,4-dimethylpentyl-p-phenylenediamino)-1,3,5-triazine and benzeneamine, N-[4-(1,3-dimethyl(butyl)imino]-2,5-cyclohexadien-1-ylidene.

2. The tire of claim 1 wherein said rubber layer boots individually extend over each of said axial outer edges of said circumferential belt ply layer and further extends to cover a portion of both of the adjacent outer surfaces of the said circumferential belt ply layer.

3. The tire of claim 2 wherein said tire contains at least two of said circumferential belt ply layers;
wherein said circumferential belt ply layers are comprised of a first belt ply layer and a second belt ply layer;
wherein said second belt ply layer underlies said first belt ply layer and extends beyond the axial outer edges of said first belt ply layer, and
wherein the each of said circumferential belt ply layers contains said rubber layer boot which extends over its axially outer edge and further extends over a portion of both of its adjacent outer surfaces; and
wherein a portion of said rubber layer boot on said outer surface of said second belt ply layer overlays a portion of the said rubber layer boot on said outer surface of said first belt ply layer.

4. The tire of claim 3 wherein a rubber wedge is positioned between said rubber layer boot on said outer surface of said first belt ply layer and said second belt ply layer and wherein said rubber wedge extends beyond the axially outer edge of at least one of said belt ply layers.

5. The tire of claim 1 wherein for said rubber layer boot composition, said conjugated diene-based elastomer is cis 1,4-polyisoprene rubber.

6. The tire of claim 5 wherein said cis 1,4-polyisoprene rubber is natural cis 1,4-polyisoprene rubber.

7. The tire of claim 1 wherein for said rubber layer boot composition, said conjugated diene-based elastomer is comprised of at least 50 phr of natural cis 1,4-polyisoprene rubber and from about 10 to about 50 phr of at least one additional conjugated diene-based elastomer.

8. The tire of claim 1 wherein for said rubber layer boot composition, said migration resistant antidegradant is comprised of 2,4,6-tris(N-1,4-dimethylpentyl-p-phenylenediamino)-1,3,5-triazine.

9. The tire of claim 3 wherein for said rubber layer boot composition, said migration resistant antidegradant is comprised of 2,4,6-tris(N-1,4-dimethylpentyl-p-phenylenediamino)-1,3,5-triazine.

10. The tire of claim 4 wherein for said rubber wedge composition, said migration resistant antidegradant is comprised of 2,4,6-tris(N-1,4-dimethylpentyl-p-phenylenediamino)-1,3,5-triazine.

11. The tire of claim 1 wherein for said rubber layer boot composition, said migration resistant antidegradant is comprised of benzeneamine, N-[4-(1,3-dimethyl(butyl)imino]-2,5-cyclohexadien-1-ylidene.

12. The tire of claim 3 wherein for said rubber layer boot composition, said migration resistant antidegradant is comprised of benzeneamine, N-[4-(1,3-dimethyl(butyl)imino]-2,5-cyclohexadien-1-ylidene.

13. The tire of claim 4 wherein for said rubber wedge composition, said migration resistant antidegradant is comprised of benzeneamine, N-[4-(1,3-dimethyl(butyl)imino]-2,5-cyclohexadien-1-ylidene.

14. The tire of claim 1 wherein for said rubber layer boot composition, said particulate reinforcing filler is rubber reinforcing carbon black.

15. The tire of claim 3 wherein for said rubber layer boot composition, said particulate reinforcing filler is rubber reinforcing carbon black.

16. The tire of claim 4 wherein for said rubber wedge composition, said particulate reinforcing filler is rubber reinforcing carbon black.

17. The tire of claim 1 wherein for said rubber layer boot composition, said particulate reinforcing filler is rubber reinforcing carbon black and precipitated silica.

18. The tire of claim 3 wherein for said rubber layer boot composition, said particulate reinforcing filler is rubber reinforcing carbon black and precipitated silica.

19. The tire of claim 17 wherein said rubber layer boot composition contains a silica coupler for said precipitated silica.

20. The tire of claim 18 wherein said rubber layer boot composition contains a silica coupler for said precipitated silica.
